(19) United States
(12) Patent Application Publication
(10) Pub. No.: US 2007/0199290 A1
(43) Pub. Date: Aug. 30, 2007

(54) Pond rake

(76) Inventor: J. Allan Main Jr., Pemberville, OH (US)

Correspondence Address: FAY SHARPE LLP, 1100 SUPERIOR AVENUE, SEVENTH FLOOR, CLEVELAND, OH, 44114, US

(21) Appl. No.: 10/557,010

(22) PCT Filed: Sep. 4, 2003
(86) PCT No.: PCT/US03/27826

§ 371 Date: Feb. 16, 2007

Related U.S. Application Data
(60) Provisional application No. 60/408,137, filed on Sep. 4, 2002.

(51) Int. Cl. A01D 44/00

(52) U.S. Cl. 56/8

(57) ABSTRACT

A pond rake includes an elongated handle and a head disposed adjacent one end of the handle and having plural tines extending therefrom. Means for enhancing downward force on the rake head as it travels through the water is provided in one preferred embodiment by a rotatable member that is actuated by the user by pulling on a rope that extends to shore. The rotatable member is generally aligned with a planar member to increase the distance the rake will travel from shore, and is then rotated to a second position that imparts the downward force on the rake head.

This application claims priority from U.S. provisional application Ser. No. 60/408,137, filed Sep. 4, 2002, the details of which are expressly incorporated herein by reference.

### BACKGROUND OF THE INVENTION

The present application relates to an apparatus and method of removing plant material, debris, sediment, or the like from the bottom of a body of water such as a pond or lake, as well as aerating the sediment and bottom surface of the water body to promote decomposition if so desired. The present invention more particularly relates to an improved pond rake that removes increased amounts of aquatic plant growth and the like from the bottom, and also finds particular application in removing golf balls from ponds or streams.

Various types of devices have been used to remove aquatic growth, sediment, and debris from the bottom surface of a pond or lake. For example, a conventional grass rake is often used that has short, rigid tines extending outwardly from a rigid support at a first end or rake head secured to an elongated pole or handle. In a primitive form, a flexible line such as a rope is secured to an opposite end of the pole. When the rake is thrown into the water, the rake head sinks to the bottom, and the user then retrieves the rake to shore by pulling on the rope. The tines of the rake scrape or remove the plant life from the bottom and bring debris to shore in an effort to prune or remove the plant life or vegetative growth in the pond, as well as removing silt and debris from the bottom surface of the pond.

Although it has been contemplated to add additional weight to the head of the rake in order to generate increased downward force, this is generally counterproductive. The additional weight simply results in a pond rake structure that is more difficult to advance into the water. A need exists to extend the range at which the rake is advanced into the pond whether it has increased weight or not. As noted above, the weight of the rake head tends to sink the tool once it is thrown into the water. Thus, commercially available pond rakes have an effective range of ten (10) to twenty (20) feet from the shore line depending on the efforts of the user.

It has been found, however, that when pulling the rake to shore, the rake has a tendency to begin to collect debris and vegetation, and then rides upwardly as the force becomes too great. The known pond rakes are thus only marginally effective.

Aeration and promoting decomposition are important considerations in the maintenance of a pond. It is helpful if the bottom surface of the pond is periodically aerated or oxygenated to promote decomposition. Mechanically raking the bottom surface of the pond stirs up the sediment and provides some limited aeration, however, increased agitation would be helpful. There is also no satisfactory means of collecting vegetation removed from the pond if it escapes the tines. In other instances, it may be advantageous to merely cut the vegetation below the water surface rather than attempting to remove the vegetation by the roots and the bottom surface of the pond.

Golf balls are periodically retrieved from water hazards associated with a golf course. Those balls that are in sufficiently good condition are reconditioned and sold at a reduced cost as reconditioned golf balls. Even at a reduced cost, these sales can provide additional income to the course owner. It is common to manually retrieve balls with a long pole, rake, or in some instances, have workers scour the bottom of the pond in wetsuits or scuba gear to collect golf balls from the water hazard. The built up sediment on the bottom of the pond makes it difficult to effectively locate golf balls embedded in the silt and sediment, and the workers typically do not want to stir up the silt/sediment since it clouds or muddies the water and makes their job more difficult.

Accordingly, a need exists for an effective pond rake that has an increased vertical force imparted to the rake tines as the rake is pulled into shore. In addition, it would be helpful if the rake were designed to improve advancement of the rake into the water, i.e., increase travel distance through the water when the pond rake is thrown from shore. Moreover, satisfying these needs with a pond rake that is simple to use, easy to manufacture, and does not add undue cost would be desirable.

### SUMMARY OF THE INVENTION

An improved pond rake is provided that includes an elongated handle, a head disposed adjacent one end of the handle and having plural times extending therefrom, and means for enhancing downward force on the rake head as it travels through the water.

A flexible line such as a rope or cable extends from the force enhancing means and selectively actuates the force enhancing means by a user by pulling the rake toward shore. The line extends around a pulley and is operatively connected to at least one rotatable wing of the force enhancing means. Biasing means such as first and second springs normally urge the wing into a first position that enhances travel from shore, and the user overcomes the biasing force to move the wing into a second position.

A second preferred embodiment of the invention is a two-way rake that can be operated manually or with the assistance of powered devices. First and second lines extend from the rake head and allow the rake head to traverse a body of water by selectively and alternately pulling on the lines.

A primary advantage of the invention resides in the improved removal of material from a body of water.

Another advantage of the invention is associated with the increased downward force exerted on the rake during selective use of the rake.

Yet another advantage is found in the increased distance from shore that the rake can travel.

Still other benefits and advantages will become apparent to those skilled in the art upon reading and understanding the following detailed description.

### BRIEF DESCRIPTION OF THE DRAWINGS

FIG. 1 is an elevational view of the subject new pond rake.

FIG. 2 is a plan view thereof.

FIG. 3 is an end view taken generally from the left hand side of FIG. 1.

FIG. 4 is an enlarged view of selected tines and illustrates a modified arrangement that enhances use of the pond rake to retrieve golf balls.

FIG. 5 is an elevational view taken generally from the left-hand end of FIG. 4.

FIG. 6 is an elevational view of a modified rake.

FIGS. 7 and 8 are top plan and elevational views, respectively, of a two-way rake.

### DETAILED DESCRIPTION OF THE INVENTION

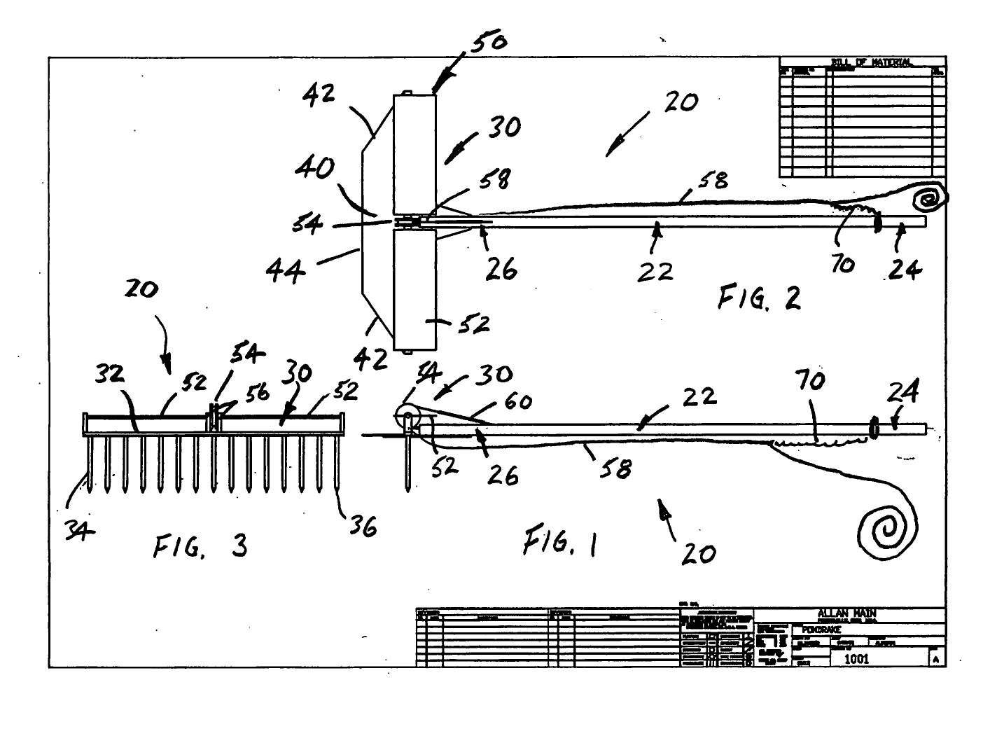

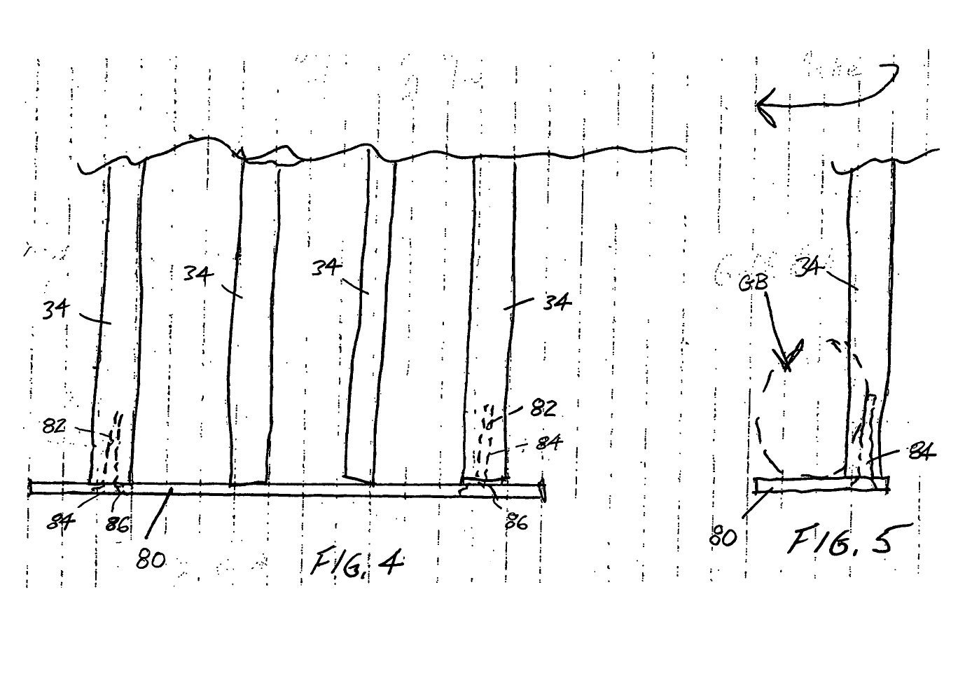

As illustrated in FIGS. 1-3, a pond rake 20 includes an elongated handle 22 having a first end 24 adapted to be grasped by a user and a second end 26 that receives the rake head 30. The rake head includes a transverse support or rigid member 32 that is preferably fixedly secured to the second end 26 of the handle. Although the handle and support can be fabricated as separate members that may be easily assembled and disassembled for use and transport, it is also contemplated that they can be formed as integral or one-piece members either by casting (metal), injection molding (plastic), welding, or the like. Extending perpendicularly from both the handle and the frame member are a series of tines 34 having pointed terminal ends 36 in the embodiment of FIGS. 1-3. The tines are shown in parallel, equi-spaced relation along the support and may be spaced a predetermined dimension depending on the intended use of the pond rake. As will be detailed below, in the preferred embodiment the tines may be selectively removed from the support, as desired, to have a larger or smaller number of tines as may be required for a particular purpose. Likewise, it is contemplated that the tines may adopt a different configuration or spacing depending on the particular end use envisioned for the pond rake, e.g., heavy foliage, sediment, cutting or removing vegetation, aeration, golf ball retrieval, etc.

Extending outwardly from the support member in a generally co-planar relation with the handle 22 is a planar surface 40. Shown here, the planar surface includes tapered edges 42 that diverge outwardly from leading edge 44 to outer terminal ends of the frame member. The planar member is preferably rigidly secured and extends outwardly and forwardly from the support for reasons that will become apparent below. The planar member is preferably a thin plate so as to not add undue weight to the pond rake. In other embodiments, the planar member is unnecessary and thus the description herein should not be deemed to limit the invention to sue of a planar member.

A means for enhancing downward forces 50 is provided on the rake head. In the preferred embodiment, the enhancing means 50 includes a movable or rotatable member such as wing or plane 52 (or pair of interconnected wings 52) that is (are) selectively pivoted by the user. A pulley or wheel 54 is mounted between a pair of support flanges 56 extending from the support. The flanges allow the pulley to rotate about its axis and, likewise, the wings 52 are mounted or secured for rotation with the pulley. Wrapped around the pulley is a flexible line such as a steel cable or rope 58 that has a first end connected to a biasing means such as first spring 60 which, in turn, is secured at its opposite end adjacent the second end of the handle. The rope proceeds from the spring 60 around the pulley, and then along the hollow handle 22 (or through the handle if desired) toward the first end 24 of the handle. A substantial additional length of rope is provided at the first end of the handle (see FIG. 4) and maintained by the user at the shore line. When the pond rake is thrown into the water, the pond rake is then pulled to shore with the rope.

A second spring 70 has one end secured to the handle first end 24 and a second end to the line adjacent the second end of the handle. This second spring provides a taut relation for the line to assure that it is maintained around the pulley and keeps the wings in a generally parallel relation with the planar surface in the absence of other forces. Thus, in a normal, at rest state, the wings 52 are generally parallel to the planar surface 40. As the rake is thrown into the pond, the planar surface 40 and the wings 52 serve an aerodynamic function that urges the rake outwardly further from shore as the weight of the rake head pulls the rake toward the bottom of the pond. In this manner, the area that can be maintained or serviced from shore dramatically increases as a result of descending to the pond bottom further from the shore line.

Once the rake head has reached the bottom surface or is disposed at a desired depth below the water surface, the rake is pulled to shore via the loose end of the flexible line. By pulling on the line, the force of the spring(s) is overcome, and the enhancing means 50, i.e., the wings 52, rotates from the normal, horizontal position to adopt an angle between zero (0) and one hundred eighty (180) degrees from the horizontal position. As the wings rotate toward perpendicular, i.e., into the same plane but in an opposite, upward direction from the tines 34, the resistance offered by the wings as the water passes thereover as the rake is pulled to shore provides a vertical force component that urges the tines toward or into the bottom surface of the pond. This downward or vertical force component greatly enhances the raking action of the tines and results in a retrieval of substantially more material to shore.

With continued reference to FIGS. 1-3, and additional reference to FIGS. 4 and 5, a modified pond rake is shown. It finds particular use in retrieving golf balls, although the embodiment of FIGS. 1-3 can be used with success for that same purpose. Enhanced results are achieved, however, by modifying the rake head to interconnect the tines together along their outer terminal ends, for example, with a thin plate 80. One manner of interconnecting the plate with the tines is to drill or tap openings 82 that extend axially inward into the tines 34 from the terminal ends 36 thereof, and secure fasteners 84 through mating openings 86 in the thin plate that extend into the tines. The thin plate has a width (dimension “x” in FIG. 5) that is sufficient to receive a golf ball GB thereon and the dimension “y” between adjacent tines is also slightly less than the diameter of a golf ball. In this manner, the tines engage and trap the golf balls therebetween and the golf balls are carried on the thin plate as the rake head is pulled into shore. Without the thin plate, the golf balls can roll away from their trapped engagement between adjacent tines as the rake is pulled to shore. In other instances, the pointed ends of the tines are eliminated and flattened ends can be used without the thin plate to effectively remove golf balls or other debris from a pond.

Again, it will be appreciated that the rake of the second preferred embodiment of FIGS. 4 and 5 can be formed from a variety of materials and in a variety of manners. For example, the rake assembly can be cast, molded, formed as separate components that are secured together or removably secured together.

Although the invention has been described relative to a preferred embodiment, numerous modifications will be apparent to those skilled in the art. For example, selective ones of the tines may be removable. Alternatively, the tines could be replaced or supplemented with a blade that cuts the vegetation below the surface but does not uproot the vegetation from the pond bottom. Another modification secures a sieve bag or open mesh net to the rake for retrieving debris as the rake is pulled ashore. For example, if the blade is used, the bag can retrieve the cut vegetation. Likewise, the bag can be used to retrieve golf balls and the like from the pond bottom while allowing the water to pass through the smaller openings in the bag/net. It is contemplated that the bag can be easily rotated or lifted toward a vertical position once it reaches shore to easily remove the contents therefrom.

It also is not necessary that the flexible line proceed through the center of the handle, although this is preferred since it limits problems associated with throwing the rake from the shore line and retrieving the pond rake from the water. It is also contemplated that additional weight can be added to the rake head. However, too much weight only impedes the ability to cast or throw the rake further from the shore line as briefly discussed above. The subject invention, however, is relatively light weight and the use of the planar surface enhances the distance the pond rake can travel from the shore line. Likewise, the movable wings also contribute to this increased distance, as well as contributing to the provision of a downward force as the rake is retrieved to shore.

The illustrated prototypes are preferably formed of fabricated metal components, such as aluminum, that are welded or riveted together. Aluminum is also preferred since it is resistant to corrosion problems that are encountered with other materials. It will be appreciated that still other materials can be used with equal success such as molded plastic components and the subject invention should not be so limited to the particular material used. Likewise, the shape and design of various components can also be altered without departing from the scope and intent of the present invention. The leading planar surface can adopt a wide variety of configurations as long as it serves to improve the ability of the rake head to move outwardly from the shore once it reaches the water. In other instances, the planar surface can be eliminated in its entirety. Likewise, the wings can adopt a wide variety of shapes or be actuated for relative movement by selective operation by the user if so desired, or intended to operate automatically in response to certain conditions.

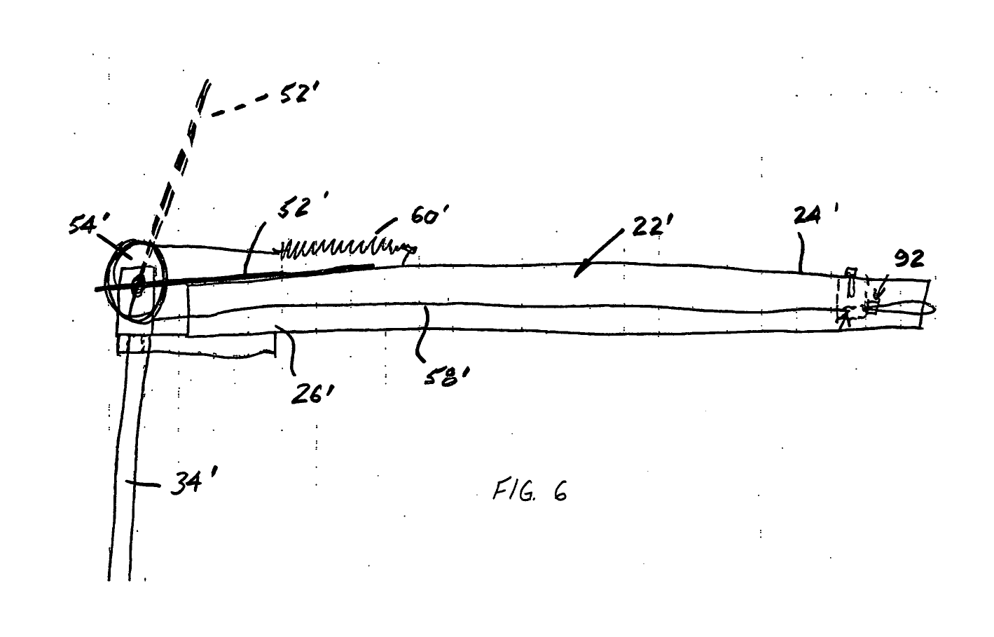

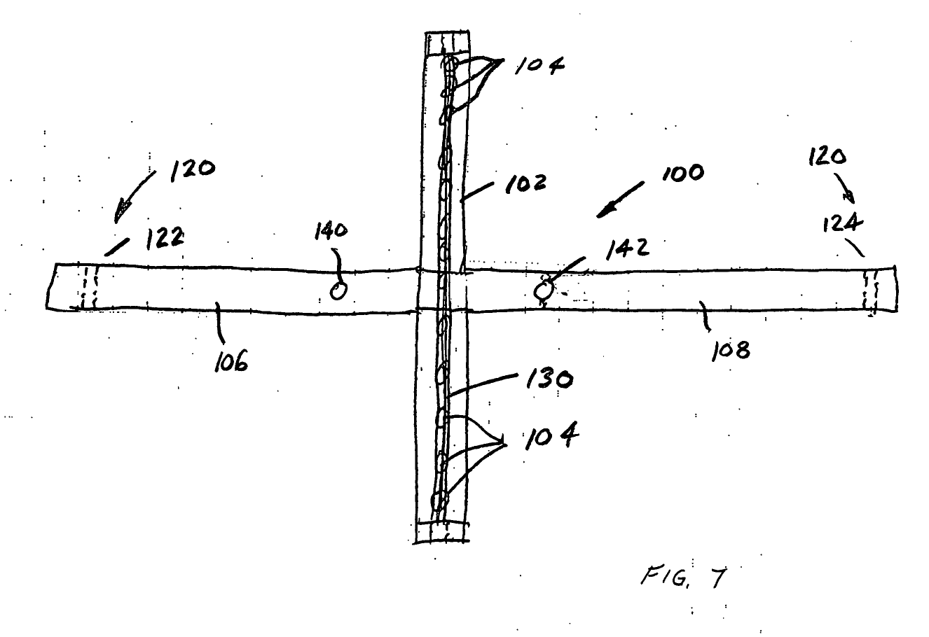

The preferred embodiment of FIG. 6 is similar to that shown in FIGS. 1-3 with some slight modifications. Like reference numerals are used to identify like elements and new numerals used to reference new components. For example, the flexible line 58′ is secured at one end to the spring 60′. However, the second spring is eliminated in this embodiment. Instead a stop assembly 90 is provided on the flexible line and handle, particularly the stop assembly includes a stop member or clasp 92 on the flexible line that is dimensioned for abutting engagement with stop member 94 on the handle. As shown in the drawing, the spring provides a slight tension or force on the flexible line that orients the movable member or wing 52′ into a substantially horizontal position when the clasp engages the stop member 94. When an additional force is provided on the cable 58′, the stop members separate and the wing is moved away from the horizontal position as represented in phantom in FIG. 6 and aids in enhancing the vertical forces on the rake tines 34′.

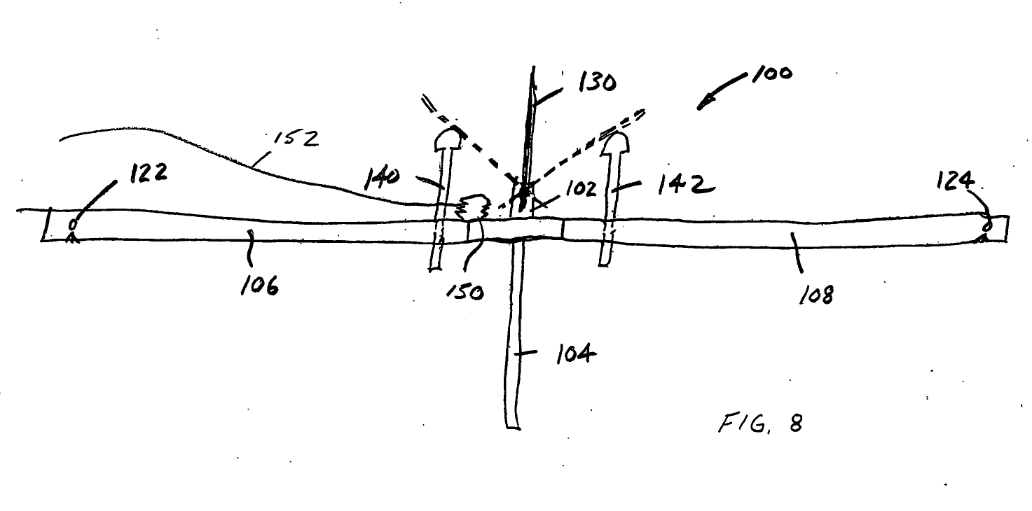

FIGS. 7 and 8 illustrate a further embodiment, referred to herein as a two-way rake 100. Particularly, includes a rake head 102 from which outwardly extend a series of spaced tines 104. First and second handles 106, 108 extend in opposite directions from the rake head. The handles include means 120 for securing flexible lines such as cables or ropes thereto. In the illustrated arrangement, the securing means is first and second openings 122, 124, one provided in each handle. Thus, a flexible line extends from each side of the rake head to provide for selective maneuvering of the rake head in response to pulling the line/rake head toward shore. By way of example, separate cables will be secured through the openings 122, 124, respectively, and gathered around a spool or powered winch (not shown) positioned on shore to selectively pull the rake head in the desired direction. As the cable on one side is brought in, the cable on the other side is let out. This allows an operator(s) to extend the rake head into the pond and selectively retrieve the rake head from one side and/or the other. The pond can be selectively traversed by moving the positions of the flexible cables to cover the entire pond.

In this embodiment, the force enhancing means or movable wing(s) 130 is pivotally connected to the rake head. The wing is not connected to a pulley or directly to the flexible lines, however, it will change its position or orientation in response to the drag imposed on the wing by the water as the rake head is moved through the body of water. The extent of movement of the wing is limited by wing stops, preferably one wing stop 140, 142 provided on each handle. The wing can pivot back and forth as the rake is traversed through the water. Thus, the wing moves in response to pulling the rake head in one direction or the other. Likewise, the wing need not achieve a precise horizontal position, but rather can be angled slightly as illustrated which still allows the rake head to traverse through the water.

The opposite ends of the cables are received on shore. If connected to a powered winch, provision can be provided for controlled slipping, i.e., a clutch, that allows the motive power to be selectively disconnected from the cable if an impediment or too large a force is imposed on the cables.

Still another consideration is to provide air from a compressor maintained on shore and a hose or line that leads to the rake. The raking action, as noted above, improves aeration of the pond by stirring the sediment as debris and vegetation are removed. The increased downward force provided by the movable wing enhances the mixing of the sediment and air. By supplying a stream of air from the compressor (for example to a hollow support 32, or through the hollow handle), increased amounts of air can be directed to the bottom surface of the pond.

The air supply line can also be used as a means to selectively raise the rake head over an impediment. This would find particular application in the two-way rake embodiment of FIGS. 7 and 8, but might also be applicable to certain instances with the other embodiments. An inflatable member 150 would be positioned on the rake head and would receive air from air supply line 152, for example, if an impediment is encountered and the clutch is actuated. The inflatable member would then float the rake head toward the surface or over the impediment, and then the air release therefrom to continue traversing the body of water. Likewise, a manual switch could be provided on shore to supply air to the inflatable member if desired.

In use, it will be appreciated that the pond rake of the present invention adds an increased vertical or downward force to the tines as the rake is pulled to shore. This increases the amount of material that may be effectively removed from the body of water. If desired, the distance from shore at which the pond rake can be advanced through the water is also increased by incorporating fixed wing-like members and/or effectively using the rotatable wings that are substantially planar during advance or travel away from shore and then are moved to a second position where the wings enhance the downward force on the rake.

The invention has been described with reference to the preferred embodiments of the invention. Modifications and alterations will be apparent to those skilled in the art and the invention is intended to cover such modifications and alterations in so far as they come with the scope of the appended claims and the equivalents thereof.

Having thus described the invention, it is now claimed:

1. A rake comprising:
an elongated handle;
a head disposed adjacent one end of the handle and having plural tines extending therefrom; and
means for enhancing downward force on the rake head as it travels through the water.

2. The pond rake of claim 1 further comprising a planar member mounted to one of the handle and head that facilitates increased travel of the rake through an associated body of water.

3. The pond rake of claim 1 further comprising means for actuating the force enhancing means.

4. The pond rake of claim 3 wherein the actuating means includes an elongated rope extending from the rake.

5. The pond rake of claim 4 wherein the rope has a first end secured to the rake, and the rope being operatively connected to the force enhancing means.

6. The pond rake of claim 5 wherein the rope has a second end that extends beyond the handle of the rake.

7. The pond rake of claim 4 wherein the actuating means includes a rotatable pulley that receives the rope therearound.

8. The pond rake of claim 7 wherein the force enhancing means is operatively engaged with the pulley.

9. The pond rake of claim 8 wherein the force enhancing means includes at least one generally planar member rotatably secured adjacent the head.

10. The pond rake of claim 9 wherein planar member is secured for rotation with the pulley, and the rope extends around the pulley so that upon pulling the rope, the planar member is rotated to a position that provides an increased downward force on the head of the rake.

11. The pond rake of claim 1 wherein the force enhancing means includes at least one generally planar member rotatably secured adjacent the head.

12. A pond rake comprising:
an elongated handle;
a rake head adjacent a first end of the handle having tines extending outwardly therefrom; and
a selectively movable member mounted to one of the handle and the rake head for movement between a first position enhancing travel of the rake through the water and a second position enhancing downward force on the rake head.

13. The pond rake of claim 12 further comprising means for biasing the movable member to one of the first and second positions.

14. The pond rake of claim 13 wherein the biasing means is a spring that urges the movable member toward the first position.

15. The pond rake of claim 13 wherein the biasing means includes a spring interposed between the handle and a rope that maintains a predetermined force on the movable member.

16. The pond rake of claim 15 further comprising a pulley secured to the movable member, the rope passing around the pulley and being biased toward a first position by a first spring.

17. The pond rake of claim 16 further comprising a second spring secured to the rope and handle.

18. The pond rake of claim 12 further comprising means forming a stop for engaging associated golf balls.

19. The pond rake of claim 19 wherein the stop is a thin plate secured to outer ends of the tines.

20. A pond rake comprising:
a rake head having tines extending outwardly therefrom; and
a selectively movable member mounted to the rake head for movement between a first position enhancing travel of the rake through the water and a second position enhancing downward force on the rake head; and
first and second flexible lines extending from the rake head for pulling the rake head in generally opposite directions.
